(19) United States
(12) Patent Application Publication
(10) Pub. No.: US 2018/0104708 A1
(43) Pub. Date: Apr. 19, 2018

(54) SPRAY QUANTITY ADJUSTABLE FOAM/LIQUID DUAL-PURPOSE DISTRIBUTION DEVICE

(71) Applicant: Guangzhou Faner Aroma Product Co., Ltd., Guangzhou City (CN)

(72) Inventor: Hsu-Hui Chang, Guangzhou City (CN)

(21) Appl. No.: 15/294,801

(22) Filed: Oct. 17, 2016

(51) Int. Cl. B05B 7/00; B05B 1/30

(52) U.S. Cl. CPC B05B 7/0025; B05B 1/30

(57) ABSTRACT

A spray quantity adjustable foam/liquid dual-purpose distribution device includes a gas compressor, a first control valve, a liquid accumulator, a second control valve, and a foam generation device that are connected to each other. The gas compressor compresses gas to generate the pressurized gas that is fed into the first control valve to be further supplied into the liquid accumulator or the foam generation device. When the pressurized gas is supplied to the liquid accumulator, the internal pressure of the liquid accumulator is increased to force liquid contained in the liquid accumulator to be fed into the second control valve, which, once opened, allows the liquid to be supplied to the foam generation device, so that the pressurized gas and the liquid are mixed in the foam generation device to generate a foamed liquid that is discharged out through an egress opening.

### TECHNICAL FIELD OF THE INVENTION

The present invention relates generally to a foam/liquid dual-purpose distribution device, which is applicable to general food and beverage service, cleaning and hygiene, and disinfection and sterilization.

### DESCRIPTION OF THE PRIOR ART

To build up a large quantity of bubbles in liquid, a common way is to mix gas and liquid to generate foamed liquid that includes therein bubbles or foams. Making of the foamed liquid often needs gas that is supplied from a gas supply device and liquid that is drawn in with a liquid pump to be supplied to a foaming apparatus in order to have the gas and the liquid mixed with each other and then, a foamed liquid having a predetermined mixture ratio between the gas and the liquid can be formed.

However, the operations of the gas supply device and the liquid pump do not allow for effective control of the ratio between the gas and the liquid so supplied or pumped. In addition, in case that the liquid pump is in operation while the gas pump is shut down, the liquid would undesirably flow into the gas supply device and this could damage or break down the gas supply device. This makes it generally not possible to supply the liquid alone. Thus, for the purposes of overcoming the above-discussed drawbacks of being impossible to effectively control the ration between the gas and the liquid and being impossible to output liquid alone and also for saving the cost of the liquid pump, the present invention aims to provide a spray quantity adjustable foam/liquid dual-purpose distribution device, which allows for effective regulation of an output quantity of pressurized gas or liquid, saving of manufacturing cost, and discharge of foam formed of any desired mixture ratio of gas and liquid and having an adjustable spray quantity or discharge of liquid alone, in order to overcome the drawbacks of the prior art and improve the utilization and performance.

### SUMMARY OF THE INVENTION

To achieve the above objective, the present invention provides a spray quantity adjustable foam/liquid dual-purpose distribution device, which generally comprises:

a gas compressor, which is provided, at predetermined locations, with a gas inlet and a gas outlet;

a first control valve, which has an end connected to the gas outlet to receive and conduct pressurized gas from the gas compressor into the first control valve, wherein the first control valve is provided, in an interior thereof, with a gas discharge channel and a gas introduction channel and the first control valve selects and controls one of the gas discharge channel and the gas introduction channel to open or close;

a liquid accumulator, which has an end in which a gas introduction opening and a liquid discharge opening are formed and the gas introduction opening is connected to the gas introduction channel and the liquid discharge opening is provided with a liquid guide device, wherein the liquid guide device has an end extending into the liquid accumulator to a location close to a bottom of the liquid accumulator and the liquid guide device has an opposite end extending through the liquid discharge opening to reach outside of the liquid accumulator;

a second control valve, which is connected to the opposite end of the liquid guide device to conduct the liquid into the second control valve, wherein the second control valve is provided, in an interior thereof, with a liquid discharge channel and the second control valve selectively controls the liquid discharge channel to open or close; and

a foam generation device, which is connected to the gas discharge channel and the liquid discharge channel, wherein the foam generation device has an end in which an egress opening is formed.

In the above-described liquid accumulator, the liquid accumulator comprises, formed therein, an interior space that is an enclosed space receiving and containing therein a liquid.

In the above-described foaming generation device, the foam generation device comprises a foaming chamber formed in an interior thereof, so that when the gas discharge channel supplies the pressurized gas into the foam generation device and the liquid discharge channel supplies the liquid into the foam generation device, the pressurized gas and the liquid are mixed with each other in the foaming chamber to form a foamed liquid and the foamed liquid is discharged out through the egress opening.

In the above-described liquid guide device, the liquid guide device comprises a sieve mounted to an end thereof to prevent impurities contained in the liquid from blocking or jamming the second control valve or the foam generation device.

In the above-described gas compressor, the gas compressor, the first control valve, and the second control valve are electrically connected to a circuit board.

In the above-described gas compressor, the gas inlet and the gas outlet are provided at the predetermined locations on an end or a side of the gas compressor.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the present invention.

FIG. 2 is a schematic view of the present invention, illustrating a condition of use of a gas discharge channel.

FIG. 3 is a schematic view of the present invention, illustrating a condition of use of a liquid discharge channel.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

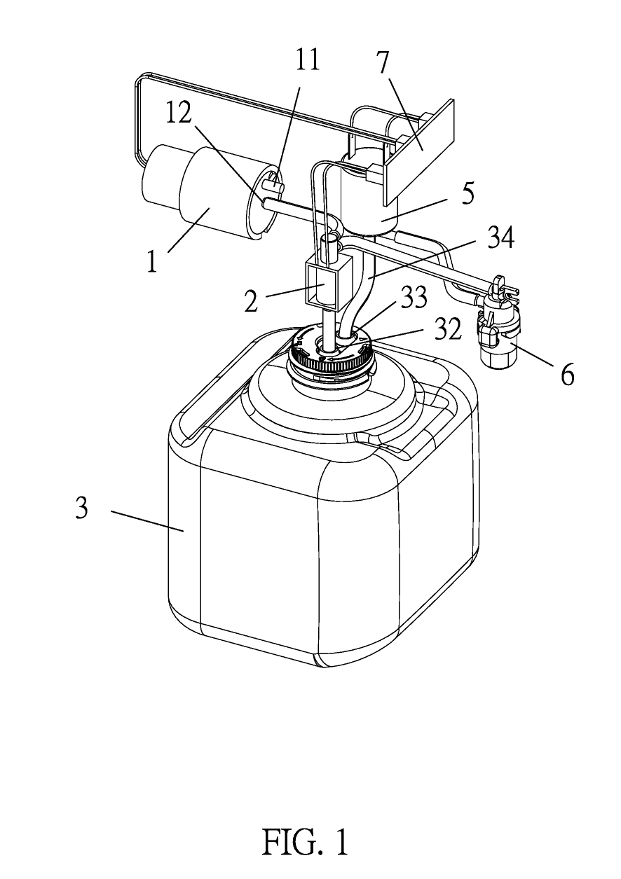

Referring to FIG. 1, which is a perspective view of the present invention, as shown in the drawing, the present invention generally comprises a gas compressor 1, and the gas compressor 1 comprises a gas inlet 11 and a gas outlet 12 formed at predetermined locations of an end or a side thereof.

A first control valve 2 is provided and the first control valve 2 has an end connected to the gas outlet 12 so that the gas compressor 1 supplies pressurized gas into the first control valve 2, wherein the first control valve 2 is provided, in an interior thereof, with a gas discharge channel 21 and a gas introduction channel 22, such that the first control valve 2 controls selection and opening of one of the gas discharge channel 21 and the gas introduction channel 22.

A liquid accumulator 3 is provided and the liquid accumulator 3 comprises an interior space that is an enclosed space in which liquid 31 is received and contained, wherein the liquid accumulator 3 is provided, in one end thereof, with a gas introduction opening 32 and a liquid discharge opening 33, where the gas introduction opening 32 is connected to the gas introduction channel 22 and the liquid discharge opening 33 is provided with and coupled to a liquid guide device 34, such that the liquid guide device 34 has an end extending deeply into the liquid accumulator 3 to a location close to a bottom of the accumulator and the liquid guide device 34 also has an opposite end extending through the liquid discharge opening 33 to reach outside of the liquid accumulator 3 and the liquid guide device 34 is provided, at an end thereof, with a sieve 4 mounted thereto to prevent impurities or contaminants contained in the liquid to block and jam the second control valve 5 or a foam generation device 6 to be described later.

A second control valve 5 is provided and the second control valve 5 is connected to said opposite end of the liquid guide device 34 to allow the liquid 31 to be fed to the second control valve 5, wherein the second control valve 5 is provided, in an interior thereof, with a liquid discharge channel 51, such that the second control valve 5 controls the liquid discharge channel 51 for selectively opening or closing the channel.

A foam generation device 6 is provided and the foam generation device 6 is connected to the gas discharge channel 21 and the liquid discharge channel 51, wherein the foam generation device 6 comprises an egress opening 61 formed in one end thereof and the foam generation device 6 comprises a foaming chamber 62 formed in an interior thereof such that when the gas discharge channel 21 supplies the pressurized gas into the interior of the foam generation device and the liquid discharge channel 51 supplies the liquid into the interior of the foam generation device 6, the pressurized gas and the liquid 31 are received into and get mixed in the foaming chamber 62 to form a foamed liquid and the foamed liquid is subsequently discharged through the egress opening.

In the above-described gas compressor 1, the gas compressor 1, the first control valve 2, and the second control valve 5 are electrically connected to a circuit board 7.

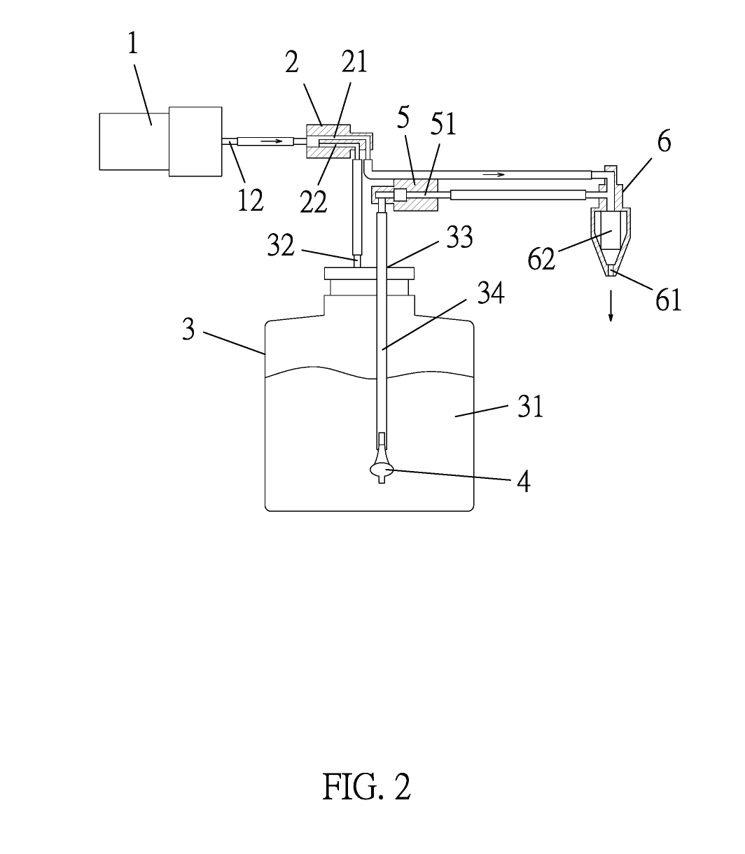

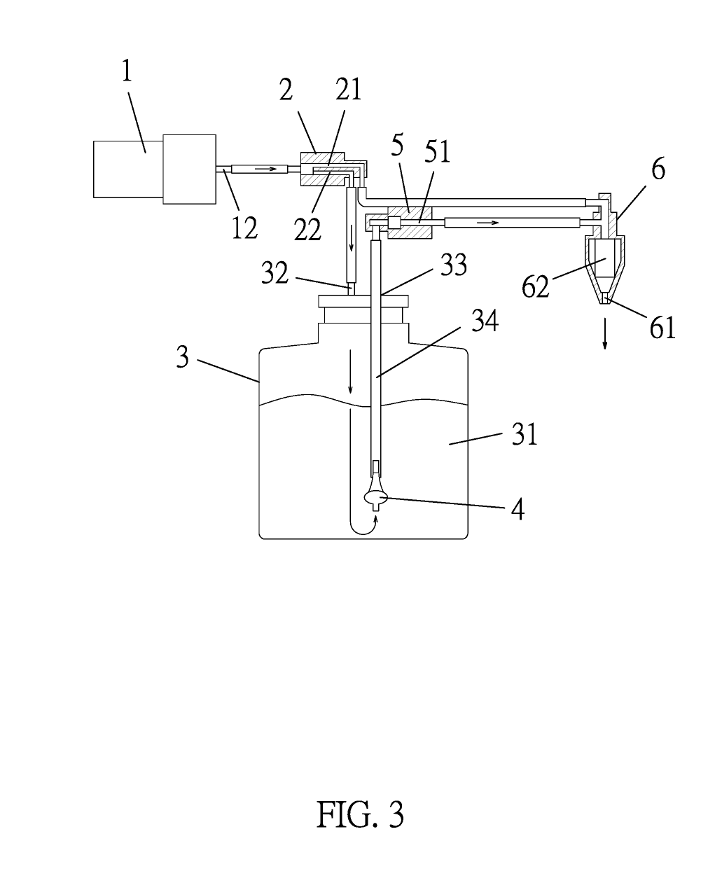

Referring to FIGS. 2 and 3, which are schematic views respectively illustrating conditions of use of the gas discharge channel and the liquid discharge channel according to the present invention, as shown in the drawings, the gas compressor 1 receives and conducts external gas through the gas inlet 11 into the gas compressor 1 to have the gas pressurized and generate pressurized gas. And, then, the gas outlet 12 feeds out the pressurized gas so that the pressurized gas, when fed into the first control valve 2, is selectively guided by the first control valve 2 to have the pressurized gas selectively conducted into the gas discharge channel 21 or the gas introduction channel 22, wherein in case that the first control valve 2 opens the gas discharge channel 21, the gas introduction channel 22 is closed to allow the pressurized gas to move through the gas discharge channel 21 into the foam generation device 6 and in case that the gas discharge channel 21 is closed, the gas introduction channel 22 would be open to allow the pressurized gas to be introduced into the liquid accumulator 3; and when the liquid accumulator 3 receives the pressurized gas introduced therein, a pressure difference is induced between the interior of the liquid accumulator 3 and the outside of the liquid accumulator 3 to cause the liquid 31 contained in the liquid accumulator 3 to be fed out through the liquid guide device 34 so that the liquid 31 so fed out is guided into the second control valve 5, wherein in case that the liquid discharge channel 51 of the second control valve 5 is in an open condition, the liquid 31 is directly fed into the foam generation device 6 to allow the pressurized gas to be mixed with the liquid 31 to generate the foamed liquid that is then fed out or discharged through the egress opening 61; in case that an excessive quantity of the liquid 31 is supplies, the second control valve 5 closes the discharge channel of the liquid 31 in order to block and prevent the liquid 31 from being further supplied into the foam generation device 6, wherein when the discharge or output of the liquid 31 is blocked, the first control valve 2 also closes the gas introduction channel 22 and simultaneously opens the gas discharge channel 21 to guide the pressurized gas into the foam generation device 6 in order to effectively control an output quantity of the pressurized gas or the liquid 31. In this way, with the first control valve 2 selectively opening or closing the gas discharge channel 21, the output quantity of the pressurized gas can be effectively controlled, and with the second control valve 5 selectively opening or closing the liquid discharge channel 51, the output quantity of the liquid 31 is effectively controlled. As such, effects of effectively controlling the output quantity of the pressurized gas or the liquid 31, saving manufacturing costs, and continuous or successive generation of foam at any desired mixture ratio can be achieved.

Further, it is also available to conduct the pressurized gas to flow only through the gas introduction channel 22 of the first control valve 2 into the liquid accumulator 3 so that the liquid 31 contained in the liquid accumulator 3 can be fed out through the liquid guide device 34 and then guided by the second control valve 5 into the foam generation device 6, and thus, in this way, the present invention is also operable to discharge liquid only without any foaming carried out. Thus, in addition to continuous or successive generation of foam of any desired mixture ratio, the present invention is also operable to discharge liquid only for use by a user.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A spray quantity adjustable foam/liquid dual-purpose distribution device, comprising:
a gas compressor, which is provided, at predetermined locations, with a gas inlet and a gas outlet;
a first control valve, which has an end connected to the gas outlet to receive and conduct pressurized gas from the gas compressor into the first control valve, wherein the first control valve is provided, in an interior thereof, with a gas discharge channel and a gas introduction channel and the first control valve selects and controls one of the gas discharge channel and the gas introduction channel to open or close;
a liquid accumulator, which comprises an interior space formed therein as an enclosed space receiving and containing therein a liquid and has an end in which a gas introduction opening and a liquid discharge opening are formed and the gas introduction opening is connected to the gas introduction channel and the liquid discharge opening is provided with a liquid guide device, wherein the liquid guide device has an end extending into the liquid accumulator to a location close to a bottom of the liquid accumulator and the liquid guide device has an opposite end extending through the liquid discharge opening to reach outside of the liquid accumulator;
a second control valve, which is connected to the opposite end of the liquid guide device to conduct the liquid into the second control valve, wherein the second control valve is provided, in an interior thereof, with a liquid discharge channel and the second control valve selectively controls the liquid discharge channel to open or close; and
a foam generation device, which is connected to the gas discharge channel and the liquid discharge channel, wherein the foam generation device has an end in which an egress opening is formed;
wherein the first control valve and the gas introduction channel are located at an upstream side of the liquid accumulator and the second control valve and the liquid guide device are located at a downstream side of the liquid accumulator;
wherein the first control valves selectively supplies pressurized gas, through the gas introduction channel, into the interior space of the liquid accumulator to generate a pressure difference that causes the liquid to flow toward the downstream by passing through the liquid guide device to the second control valve; and
wherein the liquid supplied through the second control valve is mixed with the pressurized gas selectively supplied through the first control valve and the gas discharge channel in the foam generation device that is located downstream the first and second control valves.

2. (canceled)

3. The spray quantity adjustable foam/liquid dual-purpose distribution device according to claim 1, wherein the foam generation device comprises a foaming chamber formed in an interior thereof, so that when the gas discharge channel supplies the pressurized gas into the foam generation device and the liquid discharge channel supplies the liquid into the foam generation device, the pressurized gas and the liquid are mixed with each other in the foaming chamber to form a foamed liquid and the foamed liquid is discharged out through the egress opening.

4. The spray quantity adjustable foam/liquid dual-purpose distribution device according to claim 1, wherein the liquid guide device has an outer circumferential that is set in tight engagement with the liquid discharge opening.

5. The spray quantity adjustable foam/liquid dual-purpose distribution device according to claim 4, wherein the liquid guide device comprises a sieve mounted to an end thereof to prevent impurities contained in the liquid from blocking or jamming the second control valve or the foam generation device.

6. The spray quantity adjustable foam/liquid dual-purpose distribution device according to claim 1, wherein the gas compressor, the first control valve, and the second control valve are electrically connected to a circuit board.

7. The spray quantity adjustable foam/liquid dual-purpose distribution device according to claim 1, wherein the gas inlet and the gas outlet are provided at the predetermined locations on an end or a side of the gas compressor.

8. The spray quantity adjustable foam/liquid dual-purpose distribution device according to claim 1, wherein the first control valve and the second control valve are closable simultaneously so as to keep the interior of the liquid accumulator at a predetermined pressure to allow the liquid to be immediately fed out in a next operation of the first control valve and the second control valve in order to effectively control an output quantity of the liquid.
